(19) United States
(12) Patent Application Publication
(10) Pub. No.: US 2020/0271484 A1
(43) Pub. Date: Aug. 27, 2020

(54) OPTICAL ENCODER AND CONTROL METHOD THEREOF

(71) Applicant: HIWIN MIKROSYSTEM CORP., Taichung City (TW)

(72) Inventors: TSAN-LIN CHEN, Taichung City (TW); CHIN-SUNG LIU, Taichung City (TW)

(21) Appl. No.: 16/284,466

(22) Filed: Feb. 25, 2019

(51) Int. Cl. G01D 5/347

(52) U.S. Cl. CPC G01D 5/3473; G01D 5/34707

(57) ABSTRACT

An optical encoder with modified pattern and control method for higher precision is provided. The optical encoder comprises a light emitting element, a code wheel, a grating disk and a light sensing element. The code wheel is disposed at one side of the light emitting element and comprises a plurality of tracks configured in the annular formation periodically. The grating disk is disposed at one side of the code wheel opposite to the light emitting element, and comprises a plurality of patterns parallel with each other. The light sensing element is disposed at one side of the grating disk opposite to the code wheel, and comprises a control unit and a plurality of sensing units corresponding to the patterns. The light sensing element comprises a plurality of sensing arrays wherein each of the sensing arrays comprises at least two sensing units, and the sensing units with identical space are connected with the same transmission line.

### BACKGROUND OF THE INVENTION

### Field of the Invention

The invention relates to an optical encoder, and more particularly to an optical encoder with simplified process and higher precision.

### Description of the Related Art

An optical encoder is used for measuring a mechanical geometric displacement amount by using a signal obtained from the change of sensing light. To enable the resulting analog signal to be closer to a sine-wave signal, the related art discloses that the shape of a light-receiving area is changed into a shape such as a rectangular shape, a trapezoid shape, a rhombus shape, a wave shape, or a V-shape, so as to obtain an analog signal close to a sine wave.

Although the related art has disclosed that a sensed analog signal may be adjusted to be closer to a sine-wave value by changing the shape of the light-receiving area, the shape is excessively complex and is inconvenient for processing, thus causing a disadvantage of a difficult manufacturing process.

However, the position may be misjudged due to the less light intensity through the microscale light-receiving area. Therefore, there is a need for the optical encoder to simply the process and enhance the processing by modifying the light-receiving area and the control method.

### SUMMARY OF THE INVENTION

In view of the disadvantages of prior art, the object of the present invention is to provide an optical encoder with modified pattern and control method for higher precision.

To achieve the above object, the optical encoder comprises a light emitting element, a code wheel, a grating disk and a light sensing element. The code wheel is disposed at one side of the light emitting element and comprises a plurality of tracks configured in the annular formation periodically. The grating disk is disposed at one side of the code wheel opposite to the light emitting element, and comprises a plurality of patterns parallel with each other. The light sensing element is disposed at one side of the grating disk opposite to the code wheel, and comprises a control unit and a plurality of sensing units corresponding to the patterns. The light sensing element comprises a plurality of sensing arrays wherein each of the sensing arrays comprises at least two sensing units, and the sensing units with identical space are connected with the same transmission line.

In one embodiment of the present invention, the light sensing element comprises four sensing arrays wherein each of the sensing arrays comprises a first sensing unit, a second sensing unit, a third sensing unit and a fourth sensing unit; the transmission lines of the first sensing units are connected in parallel, the transmission lines of the second sensing units are connected in parallel, the transmission lines of the third sensing units are connected in parallel and the transmission lines of the fourth sensing units are connected in parallel.

In one embodiment of the present invention, the grating disk, the light sensing element and the light emitting element are disposed at the same side of the code wheel.

In one embodiment of the present invention, each pattern comprises two circular regions and two connection regions tangent to the circular regions wherein the connection regions are placed between the circular regions and connected with each other at the apex.

In one embodiment of the present invention, each pattern comprises three circular regions and two connection regions disposed between the circular regions, and the boundaries of the connection regions are formed by tangents of the adjacent circular regions.

In one embodiment of the present invention, the circular regions comprises identical or different radius.

In one embodiment of the present invention, the control method of the control unit comprises:

receiving the signal of the transmission lines

defining the signal from the same transmission line as an independent signal;

averaging the independent signals to provide a sensing signal; and

determining the position in accordance with the sensing signal.

In one embodiment of the present invention, the control method of the control unit comprises:

receiving the signal of the transmission lines from the first sensing units to define as a first signal;

receiving the signal of the transmission lines from the second sensing units to define as a second signal;

receiving the signal of the transmission lines from the third sensing units to define as a third signal;

receiving the signal of the transmission lines from the fourth sensing units to define as a fourth signal; and

averaging the first signal, the second signal, the third signal and the fourth signal to analyze the position.

### BRIEF DESCRIPTION OF THE DRAWINGS

FIG. 1 is an exploded view of the optical encoder of the first embodiment of the present invention;

FIG. 2 is a plan view of the grating disk of the embodiment of the present invention;

FIG. 3A a plan view of the patterns on the grating disk of the embodiment of the present invention;

FIG. 3B a plan view of the patterns on the grating disk of another embodiment of the present invention;

FIG. 4 is a plan view of the light sensing element of the embodiment of the present invention;

FIG. 5 is a flow chart of the control method of the control unit of the present invention; and

FIG. 6 is an exploded view of the optical encoder of the second embodiment of the present invention.

### DETAILED DESCRIPTION OF THE PREFERRED EMBODIMENTS

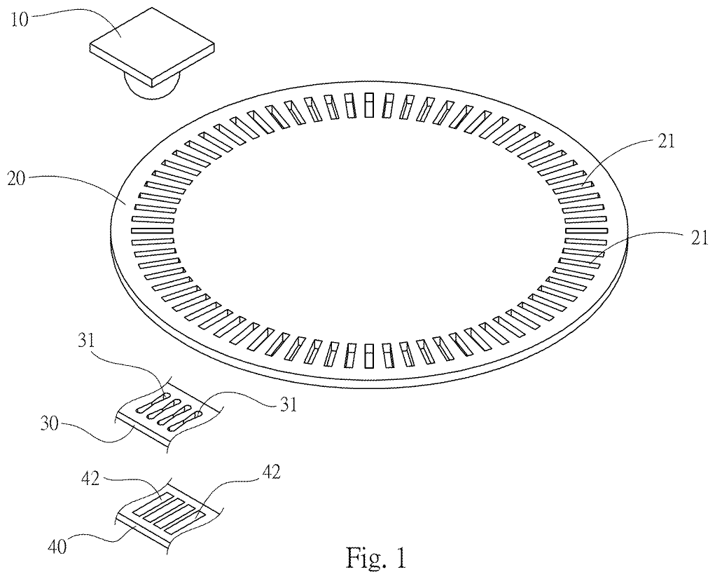

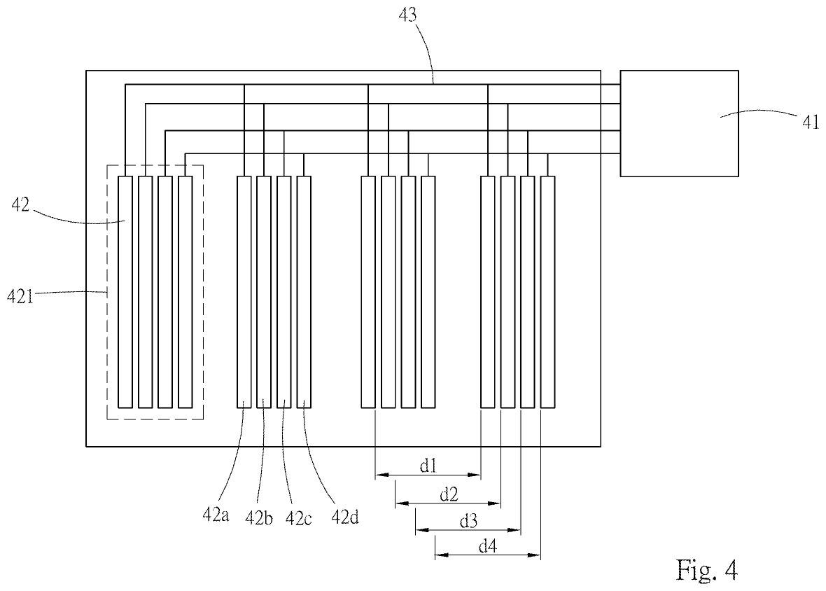

Refer to FIG. 1 and FIG. 4. The optical encoder of the first embodiment of the present invention comprises a light emitting element 10, a code wheel 20, a grating disk 30 and a light sensing element 40.

The code wheel 20 is disposed at one side of the light emitting element 10 and comprises a plurality of tracks 21 configured in the annular formation periodically. The grating disk 30 is disposed at one side of the code wheel 20 opposite to the light emitting element 10 and comprises a plurality of patterns 31. The light sensing element 40 is disposed at one side of the grating disk 30 opposite to the code wheel 20 and comprises a control unit 41 and a plurality of sensing units 42 corresponding to the patterns 31.

The optical encoder of the first embodiment of the present invention is situated at the end of a rotary shaft such that the sensing units 42 sample the light through the tracks 21 of the code wheel 20 and the patterns 31 of the grating disk 30 and output a signal to the control unit 41 by multiple transmission lines 43 to determine the position.

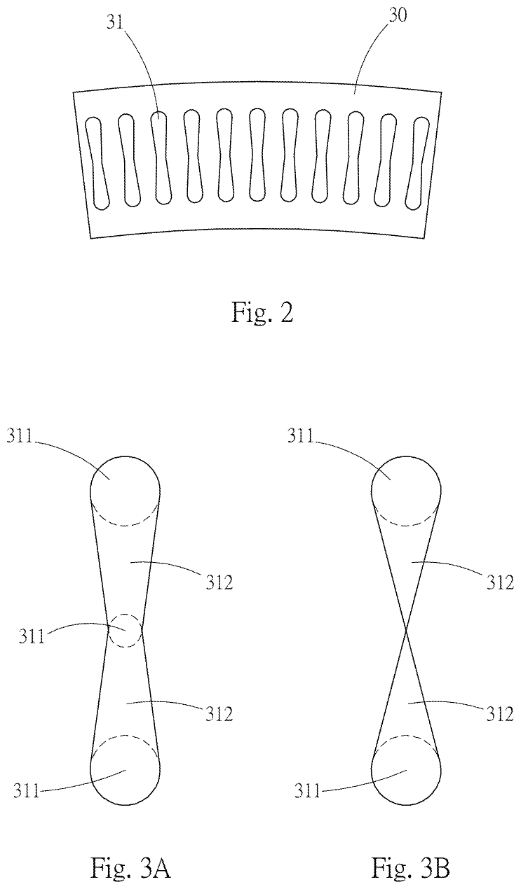

Refer to FIG. 2 and FIG. 3A. The patterns 31 of the grating disk 30 are configured in parallel wherein each pattern 31 comprises three circular regions 311 and two connection regions 312. The connection regions 312 are disposed between the circular regions 311, and the boundaries of the connection regions 312 are formed by tangents of the adjacent circular regions 311. The radius of the circular region 311 can be different in this embodiment or identical in other embodiment.

Refer to FIG. 3B illustrating another embodiment of the patterns 31. Each pattern 31 comprises two circular regions 311 and two connection regions 312 tangent to the circular regions 311. The connection regions 312 are placed between the circular regions 311 and connected with each other at the apex. The radius of the circular region 311 can be different in this embodiment or identical in other embodiment.

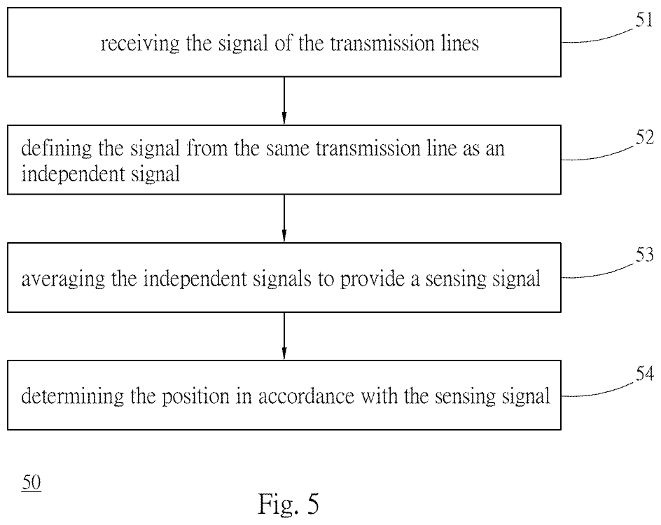

Refer to FIG. 4 and FIG. 5. The light sensing element 40 comprises four sensing arrays 421 wherein each sensing array 421 comprises a first sensing unit 42a, a second sensing unit 42b, a third sensing unit 42c and a fourth sensing unit 42d. The first sensing units 42a of the neighboring sensing arrays 421 comprise the identical space d1, and are connected with the same transmission line 43; the second sensing units 42b of the neighboring sensing arrays 421 comprise the identical space d2, and are connected with the same transmission line 43; the third sensing units 42c of the neighboring sensing arrays 421 comprise the identical space d3, and are connected with the same transmission line 43; the fourth sensing units 42d of the neighboring sensing arrays 421 comprise the identical space d4, and are connected with the same transmission line 43. The transmission lines 43 are connected between the control unit 41 and the sensing units 42 for the signal transmission.

Accordingly, the signal from the same transmission line 43 is defined as an independent signal, and the independent signals are averaged to provide a sensing signal such that the position can be determined in accordance with the sensing signal.

In this embodiment, the control unit 41 receives the signal of the transmission lines 43 from the first sensing units 42a to define as a first signal, receives the signal of the transmission lines 43 from the second sensing units 42b to define as a second signal, receives the signal of the transmission lines 43 from the third sensing units 42c to define as a third signal, and receives the signal of the transmission lines 43 from the fourth sensing units 42d to define as a fourth signal. The first signal, the second signal, the third signal and the fourth signal are averaged to analyze the position.

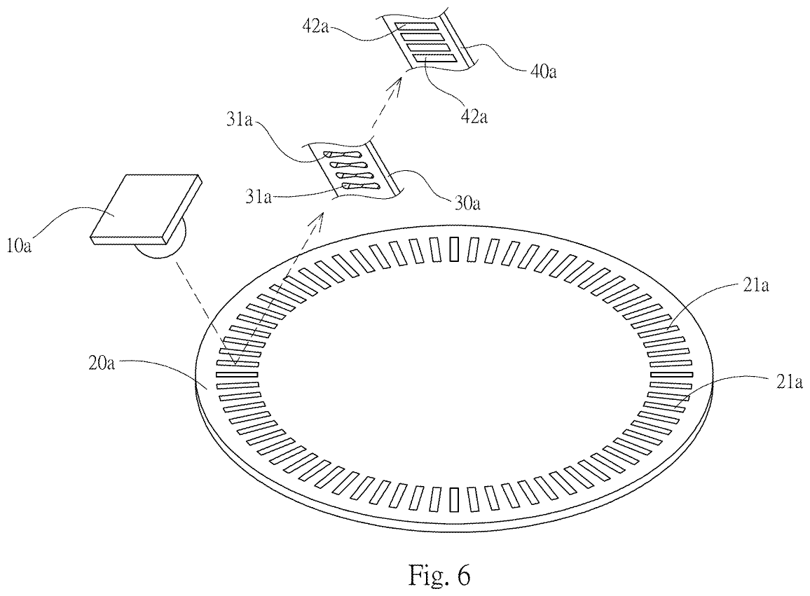

The tracks 21 of the light transmitting encoder of the above embodiment are slot formation for light transmitting. In the light reflective encoder of the embodiment shown in FIG. 6, the grating disk 30a, the light sensing element 40a and the light emitting element 10a are disposed at the same side of the code wheel 20a wherein the tracks 21a are coated with high reflective material for light reflection. Therefore, the sensing units 42a of light sensing element 40a sample the light through the tracks 21a and the patterns 31a to output a signal to the control unit 41 by multiple transmission lines 43. In addition, the grating disk 30a can be integrated with the light sensing element 40a in other embodiment.

As a result, not only the ideal sine wave is provided by modifying the patterns 31 of the grating disk 30 but the sensing precision is enhanced by the disclosed control method.

It is to be understood that the above descriptions are merely the preferable embodiment of the present invention and are not intended to limit the scope of the present invention. Equivalent changes and modifications made in the spirit of the present invention are regarded as falling within the scope of the present invention.

What is claimed is:

1. An optical encoder, comprising:
a light emitting element;
a code wheel, disposed at one side of the light emitting element and comprising a plurality of tracks configured in the annular formation periodically for light penetration or reflection;
a grating disk, comprising a plurality of patterns parallel with each other for light-transmitting; and
a light sensing element, comprising a control unit and a plurality of sensing units corresponding to the patterns wherein the sensing units sample the light through the tracks and the patterns and output a signal to the control unit by multiple transmission lines;
wherein
the light sensing element comprises a plurality of sensing arrays wherein each of the sensing arrays comprises at least two sensing units, and the sensing units with identical space are connected with the same transmission line.

2. The optical encoder as claimed in claim 1, wherein the light sensing element comprises four sensing arrays wherein each of the sensing arrays comprises a first sensing unit, a second sensing unit, a third sensing unit and a fourth sensing unit; the transmission lines of the first sensing units are connected in parallel, the transmission lines of the second sensing units are connected in parallel, the transmission lines of the third sensing units are connected in parallel and the transmission lines of the fourth sensing units are connected in parallel.

3. The optical encoder as claimed in claim 1, wherein the grating disk is disposed at one side of the code wheel opposite to the light emitting element, and the light sensing element is disposed at one side of the grating disk opposite to the code wheel.

4. The optical encoder as claimed in claim 1, wherein the grating disk, the light sensing element and the light emitting element are disposed at the same side of the code wheel.

5. The optical encoder as claimed in claim 1, wherein each of the patterns comprises two circular regions and two connection regions tangent to the circular regions; the connection regions are placed between the circular regions and connected with each other at the apex.

6. The optical encoder as claimed in claim 1, wherein each of the patterns comprises three circular regions and two connection regions disposed between the circular regions, and the boundaries of the connection regions are formed by tangents of the adjacent circular regions.

7. The optical encoder as claimed in claim 5, wherein the circular regions comprises identical or different radius.

8. The optical encoder as claimed in claim 1, wherein the control method of the control unit comprises:
receiving the signal of the transmission lines;
defining the signal from the same transmission line as an independent signal;
averaging the independent signals to provide a sensing signal; and
determining the position in accordance with the sensing signal.

9. The optical encoder as claimed in claim 2, wherein the control method of the control unit comprises:
receiving the signal of the transmission lines from the first sensing units to define as a first signal;
receiving the signal of the transmission lines from the second sensing units to define as a second signal;
receiving the signal of the transmission lines from the third sensing units to define as a third signal;
receiving the signal of the transmission lines from the fourth sensing units to define as a fourth signal; and
averaging the first signal, the second signal, the third signal and the fourth signal to analyze the position.

10. The optical encoder as claimed in claim 6, wherein the circular regions comprises identical or different radius.
